(19) United States
(12) Patent Application Publication
(10) Pub. No.: US 2026/0193121 A1
(43) Pub. Date: Jul. 9, 2026

(54) ELECTRIC APPARATUS FOR A GLASS-MAKING FURNACE

(71) Applicant: SAINT-GOBAIN ISOVER, COURBEVOIE (FR)

(72) Inventors: Marc MOULIERES, COURBEVOIE (FR); Joel GERVAIS, COURBEVOIE (FR); Mehdi ZMIRLI, SAINT-ETIENNE (FR)

(21) Appl. No.: 19/130,776

(22) PCT Filed: Nov. 16, 2023
(86) PCT No.: PCT/EP2023/082156

§ 371 Date: May 16, 2025

(30) Foreign Application Priority Data
Nov. 18, 2022 (FR) FR2211996

(51) Int. Cl. C03B 5/03; C03B 5/16

(52) U.S. Cl. CPC C03B 5/03; C03B 5/16

(57) ABSTRACT

An at least partially electric glass furnace, includes a melting tank made of refractory materials that is suitable for containing a bath of molten vitrifiable materials and a plurality of electrodes for heating the bath, the electrodes being supplied with alternating electric current by an electric apparatus including at least one transformer suitable for generating a plurality of output groups in a phase with a phase difference between each output group, each output being connected to at least one of said electrodes by a single-phase conductor generating a first magnetic field. The device includes a device installed in the first electromagnetic field, able to generate a magnetic counter-field.

The present invention belongs to the general field of glass production. It relates more particularly to an at least partially electric glass furnace suitable for melting vitrifiable materials. It also relates to a method for melting vitrifiable materials so as to be able to manufacture glass. The invention finds a particularly advantageous, although by no means limiting, application in the production of glass wool, rock wool, textile glass yarns and/or flat or hollow glass.

In the present description, “vitrifiable materials” or “raw materials” is understood to mean all materials, natural ores or synthesized products, materials derived from recycling such as cullet, etc. which can enter the composition that feeds a glass furnace. This includes silica sand, but also all additives (sodium carbonate, limestone, dolomite, alumina, etc.), waste materials (including mineral fibers) that may be produced from the production of said fibers or from construction or deconstruction sites, all possible liquid or solid fuels (composite or non-composite plastics, organic materials, coals), and any type of cullet. Also included are recyclable materials containing combustible (organic) elements such as, for example, sizing mineral fibers with a binder (of the type used in thermal or acoustic insulation or those used in the reinforcement of plastics), glazings laminated with sheets of polyvinyl butyral polymers such as windshields, glass bottles (household cullet), or any type of “composite” material combining glass and plastic materials such as certain bottles. Also recyclable are “glass-metal composites or metal compounds” such as functionalized glazings with coatings containing metals. In the description, the “bath of vitrifiable materials” or “glass bath” refer to the product of the melting of these raw materials.

Likewise, “glass” is understood to mean glass in the broad sense, that is, encompassing any material with a vitreous, glass-ceramic or ceramic matrix.

In addition, the term “manufacturing” comprises the indispensable step of melting the vitrifiable materials and, if necessary, all the subsequent steps of refining/conditioning the molten glass for its final shaping, in particular in the form of flat glass (glazings), hollow glass (bottles, jars), glass in the form of mineral wool (in particular rock wool or glass wool) used for its thermal or sound insulation properties, or even optionally glass in the form of textile yarns used in reinforcement.

Various examples of electric furnace designs are known from the state of the art, wherein current is conducted through heating electrodes in the bath of vitrifiable materials. Such electrodes can be of the “submerged” type-by being arranged vertically in the bath from the furnace floor or horizontally, passing through the side walls of the furnace-and/or of the “top-entering” type, by being immersed from the free surface of the bath.

These electrodes are supplied with alternating electrical current by an electrical installation comprising at least one transformer adapted to generate a plurality of single-phase output groups with a phase difference between each output group, each output being connected to at least one of said electrodes by a single-phase conductor.

Surprisingly, the inventors, who are glass furnace designers, observed a phenomenon of heating of certain metal structures positioned in the vicinity of these single-phase conductors. This phenomenon, a priori harmless in the case of small electric furnaces, turns out to be problematic in the case of large furnaces, in which the bath of molten vitrifiable materials has a surface area greater than 25 m², preferentially greater than 49 m², and preferentially has a distance greater than 5 m, preferentially greater than 7 m, between two opposite walls of said tank. In view of the electrical power required to supply these large furnaces, the single-phase conductors carry a current whose intensity is greater than 1000 A, preferentially greater than 4000 A, preferentially greater than 6000 A. At these levels of electrical intensity, the heating of said metal structures positioned in the vicinity of these single-phase conductors is much more significant, to such an extent that it can lead to the degradation of said metal structures.

The aim of the present invention is to remedy some or all of the disadvantages of the prior art, in particular those set out above.

To this end, and according to a first aspect, the invention relates to an at least partially electric glass furnace, comprising a melting tank made of refractory materials that is suitable for containing a bath of molten vitrifiable materials and a plurality of electrodes for heating said bath supplied with alternating electric current by an electrical installation comprising at least one transformer adapted to generate a plurality of single-phase output groups with a phase difference between each output group, each output being connected to at least one of said electrodes by a single-phase conductor generating a first magnetic field, said glass furnace being characterized in that it comprises at least one counter-reaction device, preferentially a plurality, arranged in said first magnetic field and adapted to generate a magnetic counter-field.

For the purposes of the invention, a counter-field refers to a magnetic field in the opposite direction, which therefore cancels out a first magnetic field.

The invention is based firstly on the surprising observation made by the inventors, designers of glass furnaces, of a phenomenon of heating of certain metal structures positioned close to the single-phase conductors supplying current to the electrodes, then on the understanding of this phenomenon, and finally on the implementation of a counter-reaction device making it possible to mitigate this undesired heating of these metal structures.

More precisely, it appeared to the inventors that this heating phenomenon was linked to the generation, within these metallic structures, of a current induced by the first magnetic field, i.e. by the magnetic field generated by the current flowing in the single-phase conductor. Not only does this induced current increase the risks of electrocution, but it also heats up metal structures through the Joule effect.

In response, the invention is based on the novel and inventive concept consisting of implementing a counter-reaction device arranged in said first magnetic field and adapted to generate a magnetic counter-field, thus reducing the risks of generating an induced current, and consequently the related risks of overheating and electrocution.

According to a particular embodiment, such a glass furnace comprises a single counter-reaction device arranged in said first magnetic field of each single-phase conductor and adapted to generate a magnetic counter-field.

According to a particular embodiment, such a counter-reaction device comprises a closed loop at least a portion of which is composed of a conductive metal material selected from the group comprising copper, aluminum and iron, said portion being arranged in said first magnetic field and adapted to generate said magnetic counter-field.

In concrete terms, and according to the principles of Faraday's and Lenz's laws, when a conductive material is placed in a variable magnetic field, an electric field arises therein, which in turn generates circular induced currents known as “eddy currents”. Induced currents in turn generate a magnetic counter-field that opposes the flux changes that gave rise to them, thus attenuating the latter.

According to a particular embodiment, said portion of the closed loop is in the form of a cable, a metal bar or a box.

According to a particular embodiment, said closed loop is connected to ground at a single point.

According to a particular embodiment, the voltage difference between said closed loop and said transformer is monitored, so as to detect voltage rises linked to a possible ground fault.

According to a particular embodiment, said closed loop comprises a current control system, with a cut-off threshold value for said closed loop.

Such a safety device prevents the risks of the closed loop overheating, and therefore the risks of fire.

According to a particular embodiment, said portion of the closed loop is arranged less than 1.0 meter, preferentially less than 0.5 meter, preferentially less than 0.3 meter from said single-phase conductor (7).

The positioning of said portion of the closed loop in immediate proximity to the single-phase conductor enables it to capture a greater proportion of the magnetic field emitted by the latter, and thus better attenuate it.

According to a particular embodiment, said portion of the closed loop is arranged more than 0.1 meters, preferentially more than 0.2 meters from said single-phase conductor, and/or in that said single-phase conductor is coated with an electrical insulator, preferentially plastic.

Maintaining a minimum distance between the closed loop and the single-phase conductor and/or electrically insulating the latter prevents the risks of direct contact, especially following the formation of an electric arc. This risk is particularly high during the switch-on phase of the electrical installation, when a current with a very high voltage, known as magnetizing voltage, flows through the system.

According to a particular embodiment, said melting tank is dimensioned so that said bath of molten vitrifiable materials has a surface area greater than 25 m², preferentially greater than 40 m², preferentially greater than 60 m², preferentially greater than 100 m², and preferentially has a distance between two opposite walls of said tank greater than 5 m, preferentially greater than 6.5 m.

Such dimensions relate to so-called large electric furnaces, for which the use of a two-phase system is particularly advantageous.

According to a particular embodiment, said electrical installation is adapted to generate a two-phase or three-phase alternating current.

Three-phase current offers numerous advantages, not least the fact that it is the so-called “industrial” current that is commonly distributed to plants by energy suppliers, hence the resulting adaptation of machines. Moreover, three-phase current also delivers instantaneous power with no pulsed component, unlike single-phase current, for example. It should be noted, however, that the principle of phase equilibrium tends towards a triangular or hexagonal arrangement of electrodes on the surface of the glass bath. While such a geometric constraint does not seem to pose a problem a priori in the context of a small electric furnace, it does pose a problem in the context of a large electric furnace, where the glass bath extends over an area greater than 25 m², preferentially greater than 40 m², preferentially greater than 60 m², preferentially greater than 100 m², and preferentially has a distance between two opposite walls of said tank (2) greater than 5 m, preferentially greater than 6.5 m. In such a configuration and in view of the aforementioned geometric constraints, the current tends to concentrate between the electrodes of the same and/or adjacent tank edges, thus reducing the distance covered by the current within the glass bath and therefore the resistance of the glass bath to the passage of this current. For a predetermined electrical power corresponding to the energy required to melt the vitrifiable materials, and in the context of a glass bath offering only reduced resistance, it is thus necessary to increase the intensity of the current delivered. However, wear on the electrodes and refractories making up the tank increases with the intensity of the current delivered per electrode. To overcome this problem of wear, the natural solution is to distribute the current delivered between a greater number of electrodes. However, this has the disadvantage of increasing the operating costs of these electrodes—since there are more of them—without solving certain problems of inhomogeneity in the distribution of the electric current within the glass bath.

According to a particular embodiment, at least one heating electrode is, preferentially all the heating electrodes are, immersed from the surface of said bath of molten vitrifiable materials.

Compared with so-called “submerged” type electrodes, top-entering electrodes offer a number of advantages. First of all, they avoid the difficulties associated with the passage of immersed electrodes through the refractory, and also the problems of replacing these electrodes when worn, problems with the sealing of the melting tank or else with refractory wear, due in particular to high temperatures which favor refractory attack and to powerful convection currents which develop in the vicinity of the electrodes during operation.

According to a particular embodiment, said transformer is two-phase and supplies a number of electrodes less than or equal to 16, preferentially less than or equal to 12, preferentially less than or equal to 8.

Depending on whether each output group supplies twice four electrodes, twice three electrodes or twice two electrodes, the total number of electrodes supplied by a single two-phase transformer thus varies between 16, 12 and 8 electrodes respectively.

Compared with a three-phase system and for a glass bath module of equivalent surface area-and therefore equivalent electrical power-the two-phase system offers the possibility of reducing the number of electrodes used in the furnace.

According to a particular embodiment, said transformer is adapted to generate at each output group a single-phase alternating current with a current value greater than 1000 A, preferentially greater than 4000 A, preferentially greater than 6000 A.

According to a particular embodiment, the invention relates to a method for melting vitrifiable materials implemented by means of such a glass furnace, characterized in that it comprises at least one step of electrically heating said bath of molten vitrifiable materials by means of said plurality of electrodes supplied with alternating current by said electrical installation.

According to a particular embodiment, the current value of said alternating electric current is greater than 1000 A, preferentially greater than 4000 A, preferentially greater than 6000 A.

According to a particular embodiment, the invention relates to a method for manufacturing glass wool, rock wool, textile glass yarns and/or flat or hollow glass, characterized in that it implements such a melting method.

Other features and advantages of the present invention will emerge from the non-limiting description given below, with reference to the appended drawings that illustrate an exemplary embodiment thereof. In the figures:

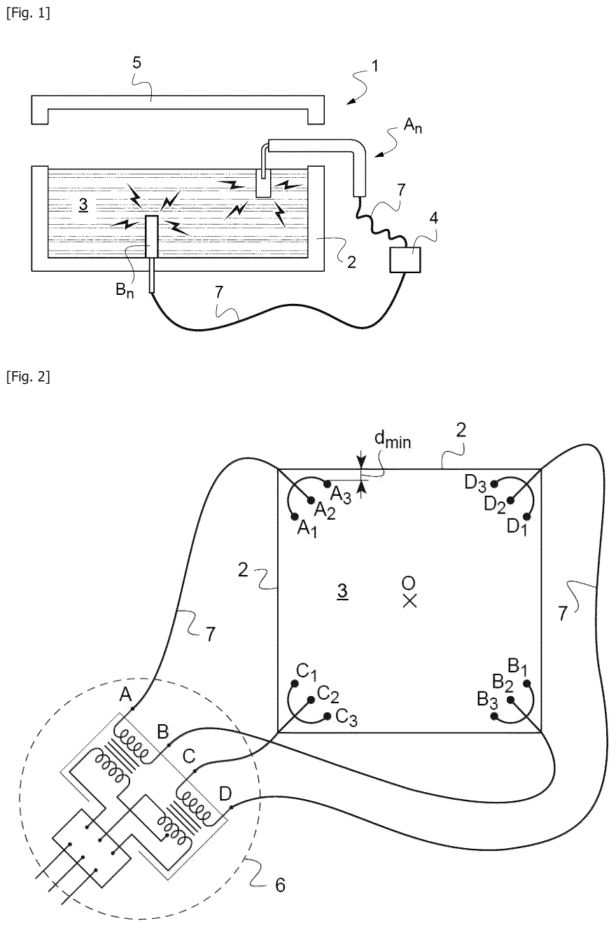

FIG. 1 shows a schematic profile view of an electric glass furnace;

FIG. 2 shows a schematic top view of the glass bath and the electrodes of an electric furnace according to a particular embodiment of the invention;

FIG. 3 schematically shows an electrical installation and a counter-reaction device of a glass furnace according to a particular embodiment of the invention;

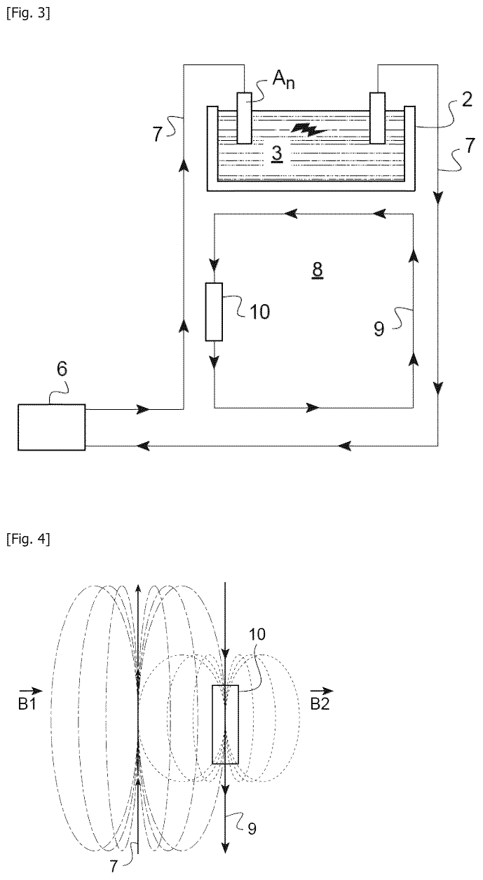

FIG. 4 schematically represents the detail of a counter-reaction device of a glass furnace according to a particular embodiment of the invention;

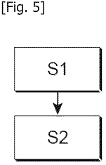

FIG. 5 is a flowchart showing the successive steps of a manufacturing method according to a particular embodiment of the invention.

FIG. 1 shows a schematic profile view of an electric glass furnace 1. Such a glass furnace 1 comprises a melting tank 2 made of refractory materials that is suitable for containing a bath 3 of molten vitrifiable materials and a plurality of heating electrodes (An, Bn) including a top-entering electrode An and a so-called “submerged” electrode Bn, these two electrodes being supplied with electric current by an electrical installation 4 to which they are connected via single-phase conductors 7.

According to alternative embodiments of the invention, all the electrodes are submerged, or all the electrodes are top-entering.

According to the particular embodiment shown in FIG. 1, the furnace 1 is fully electric and is equipped with a cold crown 5. According to alternative embodiments, such a glass furnace is of the hybrid type and comprises, in addition to the electrodes, combustion heating means, preferentially submerged and/or exposed burners, and a hot crown.

According to a particular embodiment, and as shown by FIG. 2, said electrical installation comprises a two-phase transformer 6 adapted to generate two single-phase output groups (A-B, C-D) with a 90° phase difference between each output group (A-B, C-D). According to this particular embodiment, an output group only comprises a single output (A-B, C-D) which is connected to a bundle of three pairs of electrodes ((An; Bn); (Cn; Dn) with n=1,2,3), which it supplies with single-phase alternating current. The bundles of electrodes are arranged in the bath 3 in a square shape and in such a way as to respect a central symmetry along a theoretical horizontal plane, with respect to a point O located in the center of the bath 3.

In practice, a first single-phase current is generated by the transformer 6 at the terminals of a first output group A-B and passes through the glass bath between electrodes A1, A2, A3 on the one hand, and electrodes B1, B2, B3 on the other hand, thus heating the bath 3 of vitrifiable materials by Joule effect. In parallel, a second single-phase current, of the same frequency and amplitude as the first current, but phase-shifted by 90° or π/2 radians with respect to the latter, is generated by the transformer 6 at the terminals of a second output group C-D and passes through the glass bath between electrodes C1, C2, C3 on the one hand, and electrodes D1, D2, D3 on the other, thus heating the bath 3 of vitrifiable materials by Joule effect. Overall, the electrical installation 6 is thus adapted to generate a two-phase alternating current within the glass bath 3.

FIG. 3 schematically shows an electrical installation 4 and a counter-reaction device 8, details of which are shown in FIG. 4. Such a counter-reaction device 8 is arranged in the first magnetic field B1 generated by a conductor 7 and is adapted to generate a magnetic counter-field B2.

More precisely, this counter-reaction device 8 comprises a closed loop 9, at least a portion of which takes the form of a copper bar 10 which is positioned in the first field B1 and in turn performs the function of generating the magnetic counter-field B2, thus reducing the risks of generating an induced current, and consequently the associated risks of overheating and electrocution. According to alternative embodiments, said portion 10 may take the form of a cable or a box, and be made of a conductive material, such as aluminum or iron.

According to the embodiment shown in FIG. 3, the closed loop 9 is grounded at a single point, in order notably to limit the risks of electrocution. It also comprises a system for controlling the current (not shown) flowing through the closed loop, in order to prevent the risks of the closed loop overheating, and therefore the risks of fire.

It should be noted that, even if not apparent on the figures, due to the absence of scale, the electric furnace under consideration is qualified as large, since it has a bath of molten vitrifiable materials with a surface area greater than 40 m², and a distance between the two opposite walls of said bath greater than 6.5 m. In view of the electrical power required to supply this furnace, the single-phase conductors carry a current with an intensity between 7000 and 8000 A.

FIG. 5 is a flow diagram showing the successive steps of a manufacturing method according to a particular embodiment of the invention, which comprises a first step S1 of melting vitrifiable materials by electrically heating said bath 3 of vitrifiable materials by means of a two-phase alternating current, and a second step S2 of manufacturing glass wool, rock wool, textile glass yarns and/or flat or hollow glass.

1. An at least partially electric glass furnace, comprising:
a melting tank made of refractory materials that is suitable for containing a bath of molten vitrifiable materials;
a plurality of electrodes for heating said bath supplied with alternating electric current by an electrical installation comprising at least one transformer adapted to generate a plurality of single-phase output groups with a phase difference between each output group, each output being connected to at least one of said electrodes by a single-phase conductor generating a first magnetic field, and
at least one counter-reaction device arranged in said first magnetic field and adapted to generate a magnetic counter-field.

2. The glass furnace according to claim 1, comprising a single counter-reaction device arranged in said first magnetic field of each single-phase conductor and adapted to generate a magnetic counter-field.

3. The glass furnace according to claim 1, wherein said counter-reaction device comprises a closed loop of which at least one portion is composed of a conductive metal material selected from the group comprising copper, aluminum and iron, said portion being arranged in said first magnetic field and adapted to generate said magnetic counter-field

4. The glass furnace according to claim 3, wherein said portion of the closed loop is in the form of a cable, a metal bar or a box.

5. The glass furnace according to claim 3, wherein said closed loop is grounded at a single point.

6. The glass furnace according to claim 3, wherein said closed loop comprises a current control system, with a cut-off threshold value for said closed loop.

7. The glass furnace according to claim 3, wherein said portion of the closed loop is arranged less than 1.0 meter from said single-phase conductor.

8. The glass furnace according to claim 3, wherein said portion of the closed loop is arranged more than 0.1 meters from said single-phase conductor and/or wherein said single-phase conductor is coated with an electrical insulator.

9. The glass furnace according to claim 1, wherein said melting tank is dimensioned so that said bath of molten vitrifiable materials has a surface area greater than 25 m².

10. The glass furnace according to claim 1, wherein said electrical installation is adapted to generate two-phase or three-phase alternating current.

11. The glass furnace according to claim 1, wherein at least one heating electrode is immersed from a surface of said bath of molten vitrifiable materials.

12. The glass furnace according to claim 10, wherein said transformer is two-phase and supplies a number of electrodes less than or equal to 16.

13. The glass furnace according to claim 1, wherein said transformer is adapted to generate at each output group a single-phase alternating current with a current value greater than 1000 A.

14. A method for melting vitrifiable materials implemented by a glass furnace according to claim 1, comprising electrically heating said bath of molten vitrifiable materials by said plurality of electrodes supplied with alternating current by said electrical installation.

15. The method for melting vitrifiable materials according to claim 14, wherein a current value of said alternating electric current is greater than 1000 A.

16. A method for manufacturing glass wool, rock wool, textile glass yarns and/or flat or hollow glass, comprising implementing a melting method according to claim 14.

17. The glass furnace according to claim 1, comprising a plurality of counter-reaction devices.

18. The glass furnace according to claim 7, wherein said portion of the closed loop is arranged less than 0.5 meters from said single-phase conductor.

19. The glass furnace according to claim 8, wherein said portion of the closed loop is arranged more than 0.2 meters from said single-phase conductor, and/or wherein said electrical insulator is plastic.

20. The glass furnace according to claim 9, wherein said surface area is greater than 40 m².
